(19) United States
(12) Patent Application Publication
(10) Pub. No.: US 2021/0173705 A1
(43) Pub. Date: Jun. 10, 2021

(54) METHOD AND APPARATUS FOR SOFTWARE ISOLATION AND SECURITY UTILIZING MULTI-SOC ORCHESTRATION

(71) Applicant: INTEL CORPORATION, Santa Clara, CA (US)

(72) Inventors: Christopher CORMACK, Portland, OR (US); David J. COWPERTHWAITE, Portland, OR (US); David ZAGE, Livermore, CA (US)

(21) Appl. No.: 17/263,504

(22) PCT Filed: Jul. 31, 2019
(86) PCT No.: PCT/US2019/044380

§ 371 Date: Jan. 26, 2021

Related U.S. Application Data
(60) Provisional application No. 62/714,587, filed on Aug. 3, 2018.

(51) Int. Cl. G06F 9/48; G06F 9/50; G06F 21/54; G06F 15/78

(52) U.S. Cl. CPC G06F 9/4881; G06F 9/5038; G06F 2209/508; G06F 15/7807; G06F 21/54

(57) ABSTRACT

Apparatuses, methods and storage medium associated with computing, are disclosed herein. In embodiments, a computing platform includes a plurality of System-on-Chips (SoCs) to form a corresponding plurality of local compute clusters, and an orchestration scheduler configured to receive class information of various applications, and in response, dynamically schedule different combinations of applications of different classes for execution at different ones of the local compute clusters. Other embodiments are also described and claimed.

This application claims priority to U.S. provisional application 62/714,587, entitled “Method and Apparatus for Software Isolation and Security Utilizing Multi-SOC Orchestration,” filed on Aug. 3, 2018. The specification of U.S. PA 62/714,587 is hereby fully incorporated by reference.

### TECHNICAL FIELD

The present disclosure relates to the field of computing. More particularly, the present disclosure relates to method and apparatus for group execution of in-vehicle system software of a computer-assisted or autonomous driving (CA/AD) vehicle, with each group having different combinations of software classes that takes into consideration, priority, criticality and/or trustworthiness of the software.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

In many market segments, software of multiple priority classes (high priority vs. standard priority), security classes (trusted vs. untrusted), and criticality classes (certified functionally safe vs. quality managed) is required to execute on the same computing device in parallel. This is true of the automotive market segment and Instrument Cluster software, which has workloads classified as both “high priority” as well as “certified functionally safe”. Additionally, the computing device also executes software for the rear seat entertainment system (user interface, game, movie, etc.), which is classified as “standard priority” and “quality managed”. While this problem area has solutions for simple, datacenter-centric platforms, solution leveraging accelerators for compute (GPU, CV/DL, Audio, etc.) and other heterogeneous computing resources (e.g., cryptographic accelerators) applicable to the embedded market are lacking.

Software isolation models utilizing micro-kernels, containers, virtual machines, etc., often employed in datacenter type architectures, have limits to their abilities to fully isolate workloads, especially when it comes to accelerators (GPU, CV/DL, etc.) or other shared resources such as Hardware Security Modules (HSMs). At the end of the day, there is always a layer of software (OS, micro-kernel, hypervisor, etc.) that is common across all software running on the platform, which can fail. Similarly, there are singular shared accelerators/resources that can also fail. Additionally, virtually all GPUs (all vendors) have shared internal components, which make it quite easy for the GPU to trivially crash/reset given a latent bug or malicious code. For example, if a standard priority and quality managed (untrusted) game downloaded from the Google App Store crashes due to a bug or for a malicious reason, and it is executing on a single shared GPU alongside the instrument cluster, the game may cause the GPU's SW stack to crash or the GPU to reset. This will cause the high priority and functionally safe software (instrument cluster) to stop rendering for some amount of time until recovery occurs, which should not happen. Similarly and more insidiously, an application may (purposely) consume extra computing resources, causing high-priority processes to miss their guarantees but be difficult to detect or isolate under traditional solutions.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of an environment for incorporating and using the multi-class, context and criticality-aware software execution technology of the present disclosure, in accordance with various embodiments.

FIG. 2 illustrates a hardware/software view of the in-vehicle system of FIG. 1 in further details, according to various embodiments.

FIG. 3 illustrates an example process for multi-class software execution in a computing platform of an in-vehicle system, according to various embodiments.

FIG. 4 illustrates an example computing platform suitable for use to practice aspects of the present disclosure, according to various embodiments.

FIG. 5 illustrates a storage medium having instructions for practicing methods described with references to preceding Figures, according to various embodiments.

### DETAILED DESCRIPTION

To address the challenges discussed in the background section, apparatuses, methods and storage medium associated with software isolation and security on a computing platform, such as an embedded system, are disclosed herein. Examples of embedded systems include, but are not limited to, various controllers of an in-vehicle system of a CA/AD vehicle. The software isolation and security technology is also referred to, in short, as multi-class software execution technology. The multi-class software technology includes multiple System-of-Chips (SoCs) providing multiple respective local compute clusters, and enhanced orchestration solution having an interface remoting model, enabling different mixes of classes of software to be executed in different local compute clusters, thereby enabling applications of certain classes be isolated or secured application of other classes.

In various embodiments, each SoC based local computer cluster includes its own Central Processing Unit (CPU), graphics processor unit (GPU) and hardware accelerators (such as Field Programming Gate Arrays (FPGA)). The different local compute clusters are populated with different combinations of classes of software for execution. As a result, while the executions of a first class and a second class of software may be isolated from each other, the executions of the first and second classes of software may be respectively mixed with at least a third class of software. In various embodiments, each class of software is defined in terms of its priority, criticality, and/or trustworthiness.

In various embodiments, a computing platform includes a plurality of SoCs to form a corresponding plurality of local compute clusters, and an orchestration scheduler configured to receive class information of various applications, and in response, dynamically schedule different combinations of applications of different classes for execution at different ones of the local compute clusters, to isolate or secure applications of one class from applications of at least one other class.

In various embodiments, the apparatus further comprises a plurality of orchestration agents respectively associated with and operated by the plurality of SoCs, wherein the orchestration agents are arranged to retrieve and provide the class information of the applications to the orchestration scheduler. Further, the plurality of orchestration agents may be arranged to provide live telemetry on execution of various applications at the various local compute clusters of the computing platform, as well as the status (availability) of accelerate compute resources of the local compute clusters.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

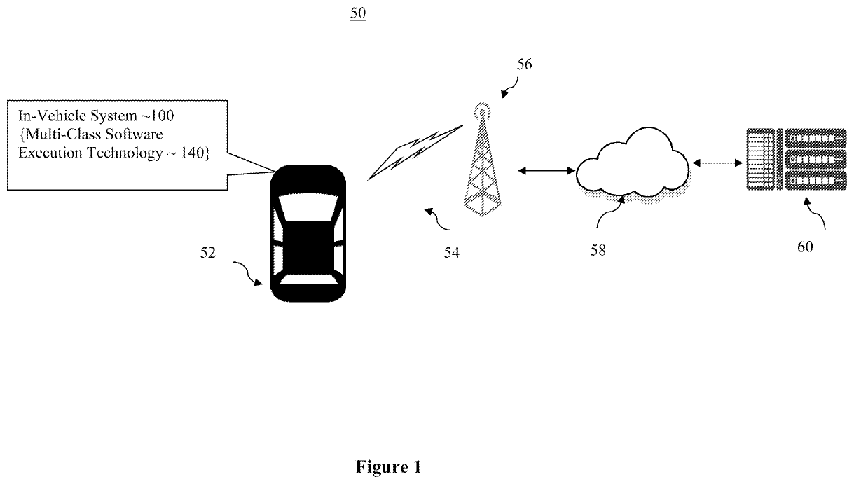

Referring now to FIG. 1, wherein an overview of an environment for incorporating and using the multi-class software execution technology of the present disclosure, in accordance with various embodiments, is shown. As illustrated, in various embodiments, example environment 50 includes vehicle 52 having an engine, transmission, axles, wheels and so forth. Further, vehicle 52 includes in-vehicle system (IVS) 100 having computing hardware elements forming a number of local compute clusters (including accelerated compute elements) to host an advanced driving assistance system (ADAS) and a number of infotainment subsystems/applications executed by the local compute clusters. The local compute clusters may also be referred to an embedded systems or embedded controllers. The ADAS system may e.g., be a camera-based ADAS with significant image processing, computer vision (CV) and/or deep learning (DL) computation needs. Examples of infotainment subsystems/applications may include instrument cluster subsystem/applications, front-seat infotainment subsystem/application, such as, a navigation subsystem/application, a media subsystem/application, a vehicle status subsystem/application, a number of rear seat entertainment subsystems/applications, and so forth. It should be noted, while for ease of understanding, the present disclosure will be presented in the context of an IVS of a CA/AD vehicle, the present disclosure is not so limited. It may be practiced in other embedded systems, such as Instrument Cluster Systems.

Further, IVS100 is provided with the multi-class software execution technology 140 of the present disclosure, where the subsystems/applications (or their tasks) are grouped into multiple classes. Each class is composed of various applications (or their tasks), allowing software designed for various purposes but of similar needs to be executed together, sharing resources. Different classes can be aggregated on the same resource as long as resource requirements do not conflict. If they conflict or exceed what an SoC can support, certain combinations will be executed separately, isolating the workload.

In various embodiments, IVS 100, on its own or in response to the user interactions, may communicate or interact with one or more off-vehicle remote content servers 60, via a wireless signal repeater or base station on transmission tower 56 near vehicle 52, and one or more private and/or public wired and/or wireless networks 58. Examples of private and/or public wired and/or wireless networks 58 may include the Internet, the network of a cellular service provider, and so forth. It is to be understood that transmission tower 56 may be different towers at different times/locations, as vehicle 52 en routes to its destination.

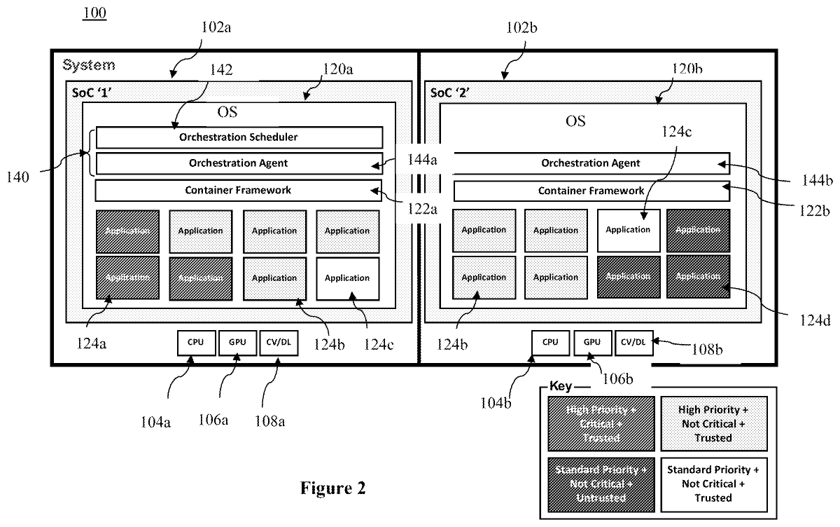

Referring now FIG. 2, wherein a hardware/software view of the in-vehicle system of FIG. 1 having the multi-class software execution technology, according to various embodiments, is shown in further details. As illustrated, for the embodiments, in-vehicle system 100 includes a computing platform having hardware 102*-108*, and software 120*-124* and 140 (including 142 and 144*) (* denotes subscripts a, b, et al). Hardware 102*-108* include SoC1 102a and SoC2 102b. Each of SoC1/SoC2 102a/102b includes central processing unit (CPU) 104a/104b, graphics processing unit (GPU) 106a/106b, and accelerators 108a/108b (such as computer vision/deep learning (CV/DL) accelerators. Software 120*-124* and 140 include operating systems (OS) 120a and 120b respectively hosted by SoC1 102a and SoC 102b. Each OS 120a/120b hosts execution of a container framework 122a/122b and applications 124a-124d. Each SoC1/SoC2 102a/102b is also referred to as a local compute cluster.

Still referring to FIG. 2, computing platform 100 is also provided with the multi-class software execution technology 140 of the present disclosure, which includes orchestration scheduler 142, and orchestration agents 144a and 144b, one per OS environment of a local compute cluster. For the illustrated embodiments, orchestration scheduler 142 is hosted by SoC1 102a/OS 120a. In alternate embodiments, orchestration scheduler 142 may be hosted by any SoC/OS. Orchestration scheduler 142 is configured to schedule execution of application by their classes.

For the illustrated embodiments, the various subsystems/applications are grouped into classes in accordance with their priority, criticality and/or trustworthiness. In embodiments, the various subsystems/applications are grouped into one of the following four example classes:
high priority, critical and trusted software 124a
high priority, non-critical and trusted software 124b
standard priority, non-critical and trusted software 124c
standard priority, non-critical and untrusted 124d.

In other embodiments, the various subsystems/applications may be grouped into other example classes, such as:
high priority and critical software
high priority and non-critical software
high priority and trusted software
standard priority and trusted software
standard priority and untrusted software

In still other embodiments, the various subsystems/applications may be classified as high priority, standard priority, critical, non-critical, trust or untrusted software.

In yet other embodiments, other attributes in addition to priority, criticality, and/or trustworthiness may also be considered in grouping applications into classes.

Orchestration scheduler 142 is configured to determine and schedule applications 124a-124d (or their tasks) for execution in SoC1 102a or 102b. In embodiments, orchestration scheduler 142 is configured to determine and schedule applications 124a-124d for execution in SoC1 102a or 102b, based on their classes. For the illustrated 4-class embodiments, orchestration scheduler 142 schedules and places the trusted classes 124a-124c for execution with SoC1 102a, regardless whether their priorities are high or standard, or whether they are critical or non-critical. For SoC2, orchestration scheduler 142 schedules and places all other classes 124b-124d for execution except the high priority, critical and trusted software 124a.

Thus, CPU 102a, GPU 104a and CV/DL accelerator 106a are shared in the execution of high priority, critical and trusted software 124a, high priority, non-critical and trusted software 124b, and standard priority, non-critical and trusted software 124c, while CPU 102b, GPU 104b and CV/DL accelerator 106b are shared in the execution of high priority, non-critical and trusted software 124b, standard priority, non-critical and trusted software 124c, and standard priority, non-critical and untrusted software 124d. However, the execution of high priority, critical and trusted software 124a is isolated from the execution of standard priority, non-critical and untrusted software 124d, and will not be impacted if standard priority, non-critical and untrusted software 124d causes CPU 102b, GPU 104b and/or CV/DL accelerator 106b to fail.

Orchestration agents 144a and 144b, respectively hosted by OS 120a and 120b, are configured to cooperate with orchestration scheduler 142 to collect and provide the class information of applications 124a-124d to orchestration scheduler 142, as well as the scheduling of applications 124a-124d to CPU 104a/104b, GPU 106a/106b and/or CV/DV accelerators 108a/108b. In embodiments, the class data of applications 124a-124d may be seeded in applications 124a-124d by a system administrator. For example, the class information may be seeded in control sections of applications 124a-124d. In embodiments, orchestration agents 144a and 144b may contact a remote cloud server for the classification of applications 124a-124d. Communications between orchestration agents 144a and 144b and OS 120a and 120b, and orchestration scheduler 142 may be exchanged in any one of a number of known inter-process communication techniques.

In other embodiments, in addition to achieving isolation and security through scheduling conflicting classes of application into SoC, isolation and security may also be achieved in a finer granularity level by allowing their execution in the same SoC, so long as the conflicting class of applications does not use the same class of resources, e.g., GPU or a CV/DL accelerator.

In various embodiments, orchestration agents 144a and 144b are further arranged to provide execution telemetry data of the scheduled applications to orchestration scheduler 142. Examples of execution telemetry data may include, but are not limited to, CPU utilization, hardware accelerator utilization, GPU utilization, memory utilization, and/or volume of input/output (I/O). In still other embodiments, orchestration agents 144a and 144b are further arranged to provide the status/availability of its corresponding CPU, hardware accelerator, GPU, memory utilization, and/or I/O devices.

Container framework 122* may be any one of a number of container management frameworks known in the art.

Except for the accelerated compute orchestration technology 140 provided, SoC1 and SoC2 102a and 102b, including CPU 104a and 104b, GPU 106a and 106b and CV/DV accelerators 108a and 108, may be any one of these elements known in the art. For examples, SoC 102* may be an Atom platforms from Intel Corporation of Santa Clara, Calif. Similarly, OS 120a and 120b, and container frameworks 122a and 122b, may be any one of these elements known or like elements in the art, with container framework 122* arranged to manage containers with applications packaged with all their execution dependencies. For example, OS 120* may be a Linux OS available from Ubuntu of London, UK. Likewise, applications 124a-124d may be any one of these elements known or like elements in the art. Example of applications 124a-124d may include, but are not limited to, instrument cluster subsystem/applications, front-seat infotainment subsystem/application, such as, a navigation subsystem/application, a media subsystem/application, a vehicle status subsystem/application, a number of rear seat entertainment subsystems/applications, and so forth.

Further, it should be noted, while for ease of understanding, only two SoCs 102a and 102b are shown, and each having one CPU 104a/104b, one GPU 106a/106b and one CV/DL accelerator 108a/108b, the disclosure is not so limited. The multi-class software execution technology of the present disclosure may be provided to computing platform with more than 2 SoCs, each having one or more CPUs, one or more GPUs, and/or one or more CV/DL accelerators. Further, some of the compute resources, such as GPU, CV/DL accelerators may be disposed outside the SoCs. Still further, orchestration scheduler 142 may also take into account other resource constraints (memory, storage, network bandwidth, proximity to display devices, and so forth) when scheduling the various classes of software for execution.

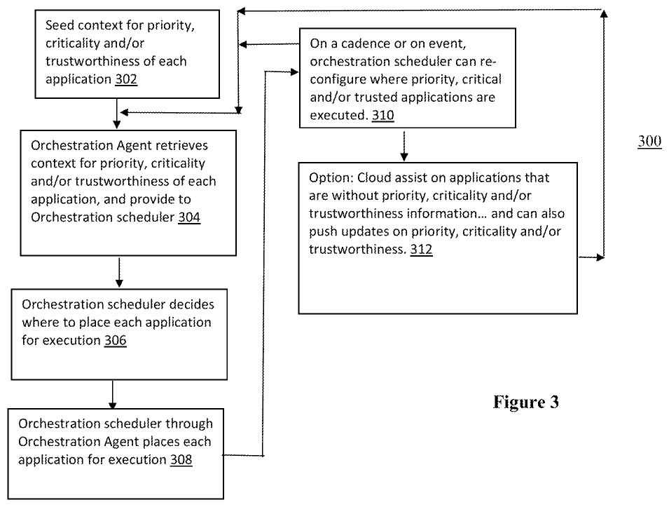

Referring now to FIG. 3, wherein a process for multi-class software execution, according to various embodiments, are shown. As illustrated process 300 for multi-class software execution on a computing platform of an in-vehicle system includes operations performed at blocks 302-310.

Process 300 starts at block 302. At block 302, context for software classification, e.g., in terms of its priority, criticality, trustworthiness, and so forth, may be seeded/provided to each application, e.g., by a system administrator. At block 304, the context for software classification, e.g., in terms of its priority, criticality, trustworthiness and so forth, may be retrieved from the applications by the orchestration agents and provided to the orchestration scheduler.

At block 306, orchestration scheduler decides where to place the applications for execution, based at least in part on their class information. In various embodiments, the decision may also be based on the available of the resources in the various SoCs, as well as resource utilization history of the applications. At block 308, orchestration scheduler places the applications to the selected local computer clusters for execution, via the orchestration agents. During execution, the orchestration agents may respectively report the execution telemetry data of the applications, and/or statuses (availability) of the resources of the SoCs.

At block 310, on a cadence or on event, the orchestration scheduler can re-configure where the different combinations of software classes are executed. From block 310, process 300 may return to block 304 and continue therefrom as earlier described, or proceed to optional block 312, before returning to block 304. At optional block 312, orchestration scheduler may contact a cloud server for applications without class information or for updates to their class information.

Thus, a novel approach to multi-class software execution in a computing platform, such as an embedded controller in an in-vehicle system has been described. The advantages of the approach may include:
Increased workload isolation, enabling mixed criticality scheduling from an orchestration solution. This is especially true for workloads that require the GPU (or other compute accelerator (CV/DL, etc.)).
A flexible and compute-scalable solution where the compute platform can be extended (add an SoC for a more powerful car) without having to rework the fundamental of the isolation and security model.
Protection of high priority, critical and trusted software from untrusted software. With this improved approach, an untrusted game may crash, but it will have been dynamically scheduled to a GPU that is guaranteed to not ever process anything related to high priority/criticality workloads like the instrument cluster. Therefore, when the game crashes or causes a GPU reset, the instrument cluster continues undisturbed.

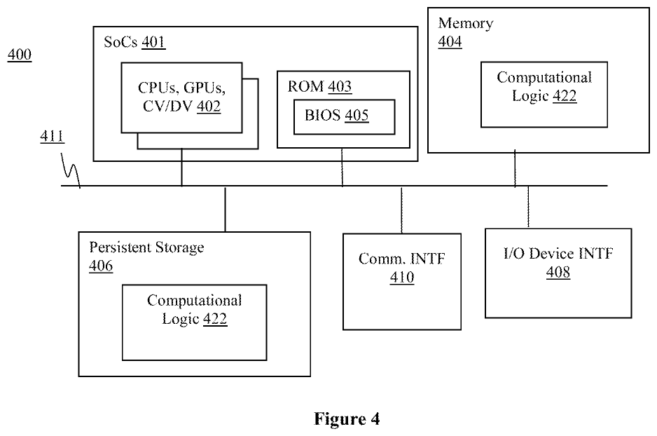

FIG. 4 illustrates an example computing platform that may be suitable for use to practice selected aspects of the present disclosure. As shown, computing platform 400 may include one or more SoCs 401. Each SoC 401 may include one or more CPUs, GPUs, CV/DV accelerators 402, and read-only memory (ROM) 403. CPUs, GPUs and CV/DL accelerators 402 may be any one of a number of CPUs, GPUs and accelerators known in the art. Similarly, ROM 403 may be any one of a number of ROM known in the art. Computing platform 400 may also include system memory 404, which may likewise be any one of a number of volatile storage known in the art.

Additionally, computing system 400 may include persistent storage devices 406. Example of persistent storage devices 406 may include, but are not limited to, flash drives, hard drives, compact disc read-only memory (CD-ROM) and so forth. Further, computer system 400 may include input/output devices 408 (such as display, keyboard, cursor control and so forth) and communication interfaces 410 (such as network interface cards, modems and so forth). The elements may be coupled to each other via system bus 412, which may represent one or more buses. In the case of multiple buses, they may be bridged by one or more bus bridges (not shown).

Each of these elements may perform its conventional functions known in the art. In particular, ROM 403 may include basic input/output system services (BIOS) 405 having a boot loader. System memory 404 and mass storage devices 406 may be employed to store a working copy and a permanent copy of the programming instructions implementing the operations associated with OS 120a/120b, container frameworks 122a/122b, orchestration scheduler 142 and/or orchestration agents 144a/144b, collectively referred to as computational logic 422. The various elements may be implemented by assembler instructions supported by CPUs 402 or high-level languages, such as, for example, C, that can be compiled into such instructions.

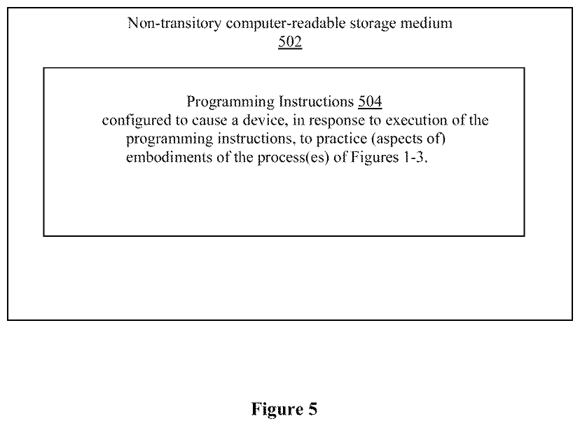

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 5 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 502 may include a number of programming instructions 504. Programming instructions 504 may be configured to enable a device, e.g., computing platform 400, in response to execution of the programming instructions, to implement (aspects of) OS 120a/120b, container frameworks 122a/122b, orchestration scheduler 142 and/or orchestration agents 144a/144b. In alternate embodiments, programming instructions 504 may be disposed on multiple computer-readable non-transitory storage media 502 instead. In still other embodiments, programming instructions 504 may be disposed on computer-readable transitory storage media 502, such as, signals.

Thus, example embodiments described include:

Example 1, which is an apparatus for computing, comprising: a plurality of System-on-Chips (SoCs) to form a corresponding plurality of local compute clusters; and an orchestration scheduler to be operated by one of the plurality of SoCs, and configured to receive class information of various applications, and in response, dynamically schedule different combinations of applications of different classes for execution at different ones of the local compute clusters, to isolate or secure applications of one class from applications of at least one other class.

Example 2 is example 1, wherein the applications are grouped into a plurality of classes, including: a first class that includes high priority, critical, or trusted ones of the applications, and a second class that includes standard priority, non-critical or untrusted ones of the applications.

Example 3 is example 2, wherein the orchestration scheduler is arranged to schedule applications of the first class that includes high priority, critical or trusted ones of the applications to execute in one of the local compute clusters, excluding execution of applications of the second class that includes standard priority, non-critical or untrusted ones of the applications from the one local compute cluster.

Example 4 is example 1, wherein the applications are grouped into a plurality of classes, including:
a first class that includes high priority, critical and trusted ones of the applications,
s second class that includes high priority, non-critical and trusted ones of the applications,
a third class that includes standard priority, non-critical and trusted ones of the applications, and
a fourth class that includes standard priority, non-critical and untrusted ones of the applications.

Example 5 is example 4, wherein the orchestration scheduler is arranged to schedule applications of the first class that includes the high priority, critical and trusted ones of the applications, applications of the second class that includes the high priority, non-critical and trusted ones of the applications, and applications of the third class that includes the standard priority, non-critical and trusted ones of the applications to execute in one of the local compute clusters, excluding execution of applications of the fourth class that includes the standard priority, non-critical and untrusted applications, in the one local compute cluster.

Example 6 is example 4, wherein the orchestration scheduler is arranged to schedule applications of the second class that includes the high priority, non-critical and trusted ones of the application, applications of third class that includes the standard priority, non-critical and trusted ones of the applications, and applications of the fourth class that includes standard priority, non-critical and untrusted ones of the applications to execute in one of the local compute clusters, excluding execution of applications of the first class that includes the high priority, critical and trusted ones of the applications, in the one local compute cluster.

Example 7 is example 1, further comprising a plurality of orchestration agents respectively associated with and operated by the plurality of SoCs, wherein the orchestration agents are arranged to retrieve and provide the class information of the applications to the orchestration scheduler.

Example 8 is example 7, wherein the orchestration agents are further configured to assist the orchestration scheduler in scheduling the different combinations of applications of different classes for execution at the corresponding different ones of the local compute clusters.

Example 9 is example 7, wherein the orchestration agents are further configured to provide the orchestration scheduler with execution telemetry information of the different combinations of applications of different classes scheduled for execution at the corresponding different ones of the local compute clusters.

Example 10 is example 9, wherein the telemetry information includes central processing unit (CPU) utilization, hardware accelerator utilization, graphics processor unit (GPU) utilization, memory utilization, or volume of input/output (I/O).

Example 11 is example 7, wherein the orchestration agents are further configured to provide the orchestration scheduler with statuses of compute resources of the corresponding local compute clusters.

Example 12 is example 11, wherein at least one of SoC comprises a graphics processor unit or a hardware accelerator.

Example 13 is any one of examples 1-12, wherein the apparatus is an embedded system, part of an in-vehicle system, of a computer-assisted/autonomous driving (CA/AD) vehicle.

Example 14 is a method for computing, comprising: receiving, by an orchestration scheduler of an embedded system, class information of a plurality of applications, from orchestration agents of the embedded system the embedded system having a plurality of System-on-Chips (SoCs) forming respective local compute clusters, and having a plurality of orchestration agents correspondingly associated with the local computer clusters; deciding, by the orchestration scheduler, which of the local compute clusters to place an application for execution, based at least in part on the class information of the application; and scheduling, by a corresponding one of the orchestration agents, execution of the application at the local compute cluster decided by the orchestration scheduler, to isolate or secure the application from applications of at least one other class.

Example 15 is example 14, wherein the application is a selected one of:
a critical and trusted application,
a non-critical and trusted application, or
a non-critical and untrusted application.

Example 16 is example 15, wherein if the application is a critical and trusted application, or a non-critical and trusted application, deciding comprises deciding to schedule execution of the application in a local compute cluster, where execution of non-critical and untrusted applications are excluded.

Example 17 is example 14, further comprising providing, by the orchestration agents, to the orchestration scheduler, execution telemetry information of the applications being executed at the corresponding ones of the local compute clusters.

Example 18 is example 14, further comprising providing, by the orchestration agents, to the orchestration scheduler, with statuses of compute resources of the corresponding local compute clusters.

Example 19 is any one of examples 14-18, wherein receiving, deciding and scheduling by the orchestration scheduler and the orchestration agents on the embedded system comprise receiving, deciding and scheduling by the orchestration scheduler and the orchestration agents in an in-vehicle system of a computer-assisted/autonomous driving (CA/AD) vehicle.

Example 20 is at least one computer-readable medium (CRM) having instructions stored therein, to cause an embedded system, in response to execution of the instruction, to operate a plurality of orchestration agents in a plurality of local compute clusters formed with a plurality of corresponding System-of-Chips (SoCs); wherein the plurality of orchestration agents provide class information of a plurality of applications, the class information of the plurality of applications being used to schedule different combinations of the applications of different classes for execution at different ones of the local compute clusters to isolate or secure applications of one class from applications of at least one other class; and wherein each of the plurality of orchestration agents provides execution telemetry information of the applications being executed at the corresponding local compute clusters.

Example 21 is example 20, wherein each of the plurality of orchestration agents further provides to the orchestration scheduler, with statuses of compute resources of the corresponding local compute clusters.

Example 22 is example 21, wherein the compute resources of at least one local compute cluster formed with a SoC comprise a graphics processing unit or a hardware accelerator.

Example 23 is example 20, wherein for of the plurality of applications, the plurality of orchestration agents provide whether the application is a high priority or standard priority application, a critical or non-critical application, or a trusted or non-trusted application.

Example 24 is example 20, wherein the orchestration agents provide execution telemetry information of applications executing in its corresponding locate compute cluster, that include high priority and non-critical applications, and standard priority and non-critical applications, but not high priority and critical application, which are excluded from being executed in the corresponding local compute cluster.

Example 25 is any one of examples 20-24, wherein the embedded system is part of an in-vehicle system of a computer-assisted/autonomous driving (CA/AD) vehicle.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. An apparatus for computing, comprising:
a plurality of System-on-Chips (SoCs) to form a corresponding plurality of local compute clusters; and
an orchestration scheduler to be operated by one of the plurality of SoCs, and configured to receive class information of various applications, and in response, dynamically schedule different combinations of applications of different classes for execution at different ones of the local compute clusters, to isolate or secure applications of one class from applications of at least one other class.

2. The apparatus of claim 1, wherein the applications are grouped into a plurality of classes, including:
a first class that includes high priority, critical, or trusted ones of the applications, and
a second class that includes standard priority, non-critical or untrusted ones of the applications.

3. The apparatus of claim 2, wherein the orchestration scheduler is arranged to schedule applications of the first class that includes high priority, critical or trusted ones of the applications to execute in one of the local compute clusters, excluding execution of applications of the second class that includes standard priority, non-critical or untrusted ones of the applications from the one local compute cluster.

4. The apparatus of claim 1, wherein the applications are grouped into a plurality of classes, including:
a first class that includes high priority, critical and trusted ones of the applications,
s second class that includes high priority, non-critical and trusted ones of the applications,
a third class that includes standard priority, non-critical and trusted ones of the applications, and
a fourth class that includes standard priority, non-critical and untrusted ones of the applications.

5. The apparatus of claim 4, wherein the orchestration scheduler is arranged to schedule applications of the first class that includes the high priority, critical and trusted ones of the applications, applications of the second class that includes the high priority, non-critical and trusted ones of the applications, and applications of the third class that includes the standard priority, non-critical and trusted ones of the applications to execute in one of the local compute clusters, excluding execution of applications of the fourth class that includes the standard priority, non-critical and untrusted applications, in the one local compute cluster.

6. The apparatus of claim 4, wherein the orchestration scheduler is arranged to schedule applications of the second class that includes the high priority, non-critical and trusted ones of the application, applications of third class that includes the standard priority, non-critical and trusted ones of the applications, and applications of the fourth class that includes standard priority, non-critical and untrusted ones of the applications to execute in one of the local compute clusters, excluding execution of applications of the first class that includes the high priority, critical and trusted ones of the applications, in the one local compute cluster.

7. The apparatus of claim 1, further comprising a plurality of orchestration agents respectively associated with and operated by the plurality of SoCs, wherein the orchestration agents are arranged to retrieve and provide the class information of the applications to the orchestration scheduler.

8. The apparatus of claim 7, wherein the orchestration agents are further configured to assist the orchestration scheduler in scheduling the different combinations of applications of different classes for execution at the corresponding different ones of the local compute clusters.

9. The apparatus of claim 7, wherein the orchestration agents are further configured to provide the orchestration scheduler with execution telemetry information of the different combinations of applications of different classes scheduled for execution at the corresponding different ones of the local compute clusters.

10. The apparatus of claim 9, wherein the telemetry information includes central processing unit (CPU) utilization, hardware accelerator utilization, graphics processor unit (GPU) utilization, memory utilization, or volume of input/output (I/O).

11. The apparatus of claim 7, wherein the orchestration agents are further configured to provide the orchestration scheduler with statuses of compute resources of the corresponding local compute clusters.

12. The apparatus of claim 11, wherein at least one of SoC comprises a graphics processor unit or a hardware accelerator.

13. The apparatus of claim 1, wherein the apparatus is an embedded system, part of an in-vehicle system, of a computer-assisted/autonomous driving (CA/AD) vehicle.

14. A method for computing, comprising:
receiving, by an orchestration scheduler of an embedded system, class information of a plurality of applications, from orchestration agents of the embedded system the embedded system having a plurality of System-on-Chips (SoCs) forming respective local compute clusters, and having a plurality of orchestration agents correspondingly associated with the local computer clusters;
deciding, by the orchestration scheduler, which of the local compute clusters to place an application for execution, based at least in part on the class information of the application; and
scheduling, by a corresponding one of the orchestration agents, execution of the application at the local compute cluster decided by the orchestration scheduler, to isolate or secure the application from applications of at least one other class.

15. The method of claim 14, wherein the application is a selected one of:
a critical and trusted application,
a non-critical and trusted application, or
a non-critical and untrusted application.

16. The method of claim 15, wherein if the application is a critical and trusted application, or a non-critical and trusted application, deciding comprises deciding to schedule execution of the application in a local compute cluster, where execution of non-critical and untrusted applications are excluded.

17. The method of claim 14, further comprising providing, by the orchestration agents, to the orchestration scheduler, execution telemetry information of the applications being executed at the corresponding ones of the local compute clusters.

18. The method of claim 14, further comprising providing, by the orchestration agents, to the orchestration scheduler, with statuses of compute resources of the corresponding local compute clusters.

19. The method of claim 14, wherein receiving, deciding and scheduling by the orchestration scheduler and the orchestration agents on the embedded system comprise receiving, deciding and scheduling by the orchestration scheduler and the orchestration agents in an in-vehicle system of a computer-assisted/autonomous driving (CA/AD) vehicle.

20. At least one computer-readable medium (CRM) having instructions stored therein, to cause an embedded system, in response to execution of the instruction, to operate a plurality of orchestration agents in a plurality of local compute clusters formed with a plurality of corresponding System-of-Chips (SoCs):
wherein the plurality of orchestration agents provide class information of a plurality of applications, the class information of the plurality of applications being used to schedule different combinations of the applications of different classes for execution at different ones of the local compute clusters to isolate or secure applications of one class from applications of at least one other class; and
wherein each of the plurality of orchestration agents provides execution telemetry information of the applications being executed at the corresponding local compute clusters.

21. The CRM of claim 20, wherein each of the plurality of orchestration agents further provides to the orchestration scheduler, with statuses of compute resources of the corresponding local compute clusters.

22. The CRM of claim 21, wherein the compute resources of at least one local compute cluster formed with a SoC comprise a graphics processing unit or a hardware accelerator.

23. The CRM of claim 20, wherein for of the plurality of applications, the plurality of orchestration agents provide whether the application is a high priority or standard priority application, a critical or non-critical application, or a trusted or non-trusted application.

24. The CRM of claim 20, wherein the orchestration agents provide execution telemetry information of applications executing in its corresponding locate compute cluster, that include high priority and non-critical applications, and standard priority and non-critical applications, but not high priority and critical application, which are excluded from being executed in the corresponding local compute cluster.

25. The CRM of claim 20, wherein the embedded system is part of an in-vehicle system of a computer-assisted/autonomous driving (CA/AD) vehicle.
